(19) United States
(12) Patent Application Publication
(10) Pub. No.: US 2026/0359892 A1
(43) Pub. Date: Nov. 12, 2026

(54) LOW POWER METHOD AND SYSTEM FOR PROCESSING DATA AND TRANSMITTING SAME TO AN OFFLINE REMOTE COMPUTER

(71) Applicant: JPMorgan Chase Bank, N.A., New York, NY (US)

(72) Inventor: Mehak GOYAL, Ludhiana (IN)

(73) Assignee: JPMorgan Chase Bank, N.A., New York, NY (US)

(21) Appl. No.: 19/249,410

(22) Filed: Jun. 25, 2025

(30) Foreign Application Priority Data
May 9, 2025 (IN) 202511045117

(51) Int. Cl. G06Q 40/06; G06Q 30/0202

(52) U.S. Cl. CPC G06Q 40/06; G06Q 30/0202

(57) ABSTRACT

A method and a system for providing sustainable investment analysis are disclosed. The method includes: collecting a set of data associated with an investment industry from a plurality of sources and determining a plurality of patterns from the set of data using at least one machine learning-based model; evaluating sustainability for the set of data based on the plurality of patterns and performing a financial analysis on the collected set of data and emerging market opportunities to extract a plurality of features, based on the evaluated sustainability and the plurality of patterns; forecasting growth of the investment industry to predict future growth of the investment industry, based on the financial analysis and plurality of patterns; identifying a plurality of investment risks associated with the collected set of data based on the forecasted growth of the investment industry; and generating personalized investment recommendations.

### CROSS-REFERENCE TO RELATED APPLICATIONS

This application claims priority benefit from Indian Application No. 202511045117, filed on May 9, 2025, in the India Patent Office, which is hereby incorporated by reference in its entirety.

### FIELD OF THE DISCLOSURE

The present invention relates to sustainable investment, more specifically relates to a low power method and system for providing a sustainable investment analysis.

### BACKGROUND INFORMATION

In today's rapidly evolving technological landscape, several investors face challenges to balance profitability with sustainability goals. Traditional investment approaches focus solely on financial performance, without fully accounting for the environmental and social impacts of investment opportunities. This limits the ability to identify investments that align with sustainability objectives, which are becoming increasingly important to investors, particularly as environmental concerns, regulatory pressures, and consumer demand for responsible business practices grow.

As technology firms or companies operate with complex supply chains, high energy consumption, and significant environmental footprints (including carbon emissions, e-waste, and resource depletion), investors must evaluate not only financial performance but also sustainability metrics that reflect environmental, social, and governance considerations. However, lack of comprehensive, standardized, and easily accessible sustainability data presents a significant challenge for investors trying to assess and compare the long-term impact and viability of tech investments.

Existing investment platforms may aggregate some sustainability-related data, but they often fail to provide the granular, real-time analysis required to make informed investment decisions. Moreover, investors often lack tools to assess the risk and potential rewards of sustainable investments, given the uncertainty surrounding long-term sustainability trends, market volatility, and regulatory changes. The rise of greenwashing where companies falsely claim to be environmentally or socially responsible, further complicates the decision-making process.

Hence, in view of these and other existing limitations, there arises an imperative need to provide an efficient solution to overcome the above-mentioned limitations and to provide a method and system providing sustainable investment analysis.

Any such solution to the extent it uses artificial intelligence (AI) and/or machine learning (ML) grapples with the underlying electrical power requirements and computer resources to implement. A typical inquiry to general AI consumes on the order of ten times the amount of electrical power as a comparable Google search. OpenAI CEO Sam Altman recently stated that the company spends tens of millions of dollars on electricity costs because people say “please” and “thank you” to ChatGPT. The growth of AL/ML has become an industry wide technical problem in the provision of power to support AI/ML. The recent activity by Microsoft to obtain access to power from the Three Mile Island nuclear facility to support its data operations is an example of the industry wide need for power. Accordingly, any such technical solution should include features that reduce the overall power consumption of the underlying process.

Another technical problem is the use of a recurrent neural network (RNN) as any part of AI/ML. As an RNN receives longer sequences, the gradients used to update weights during learning can become very small or very large. If they become very small, the output over time fades or decays. If the gradients become too large, the network becomes unstable as output explodes as values go to infinity.

### SUMMARY

The present disclosure, through one or more of its various aspects, embodiments, and/or specific features or sub-components, provides, inter alia, various systems, servers, devices, methods, media, programs, and platforms for providing sustainable investment analysis.

According to an aspect of the present disclosure, a method for providing a sustainable investment analysis is disclosed. The method is being implemented by at least one processor. The method includes collecting, by the at least one processor, a set of data associated with an investment industry from a plurality of sources. The method further includes determining, by the at least one processor, a plurality of patterns from the collected set of data using at least one machine learning-based model. The at least one machine learning-based model is configured to identify trends and correlations within the set of data. The method further includes evaluating, by the at least one processor, sustainability for the collected set of data based on the plurality of patterns. The method further includes performing, by the at least one processor, a financial analysis on the collected set of data and emerging market opportunities to extract a plurality of features, based on the evaluated sustainability and the plurality of patterns. The method further includes forecasting, by the at least one processor, growth of the investment industry using the at least one machine learning-based model to predict future growth of the investment industry, based on the financial analysis and the plurality of patterns. The method also includes identifying, by the at least one processor, a plurality of investment risks associated with the collected set of data based on the forecasted growth of the investment industry. The method includes generating, by the at least one processor, personalized investment recommendations based on at least one from among the financial analysis, predicted future growth of the investment industry and the plurality of investment risks. The personalized investment recommendations are tailored to individual investor profiles and preferences.

In accordance with an exemplary embodiment, the method may further include displaying, by the at least one processor, the personalized investment recommendations to a plurality of users through an interactive dashboard.

In accordance with an exemplary embodiment, collecting the set of data may further include pre-processing, by the at least one processor, the collected set of data using at least one technique from among natural language processing and optical character recognition.

In accordance with an exemplary embodiment, the method may include storing, by the at least one processor, the collected set of data in a set of databases. The set of databases correspond to one of: SQL databases and non-SQL databases.

In accordance with an exemplary embodiment, prior to performing the financial analysis, the method may include performing a natural language processing-based sentiment analysis on the collected set of data; and utilizing a cluster of machine learning models to identify emerging market opportunities.

In accordance with an exemplary embodiment, the set of data may include at least one from among environmental, social and governance data, industry data, financial statements and reports, industry reports, social media data, and income reports.

In accordance with an exemplary embodiment, the plurality of features may include at least one from among revenue growth, profitability metrics, liquidity analysis, and capital expenditure

In accordance with an exemplary embodiment, the plurality of investment risks may include at least one from among debt levels and liquidity risks, regulatory risks, market volatility risks, and technological obsolescence risks.

According to another aspect of the present disclosure, a computing device configured to provide a sustainable investment analysis is disclosed. The computing device includes a processor, a memory storing instructions, and a communication interface coupled to each of the processor and the memory. The processor may be programmed to cooperate with the instructions to perform operations including: collecting a set of data associated with an investment industry from a plurality of sources; determining a plurality of patterns from the collected set of data using at least one machine learning-based model, wherein the at least one machine learning-based model is configured to identify trends and correlations within the set of data; evaluating sustainability for the collected set of data based on the plurality of patterns; performing a financial analysis on the collected set of data and emerging market opportunities to extract a plurality of features, based on the evaluated sustainability and the plurality of patterns; forecasting growth of the investment industry using the at least one machine learning-based model to predict future growth of the investment industry, based on the financial analysis and the plurality of patterns; identifying a plurality of investment risks associated with the collected set of data based on the forecasted growth of the investment industry; and generating personalized investment recommendations based on at least one from among the financial analysis, predicted future industry growth and the plurality of investment risks.

In accordance with an exemplary embodiment, the operations may further include displaying the personalized investment recommendations to a plurality of users through an interactive dashboard.

In accordance with an exemplary embodiment, to collect the set of data, the operations may include pre-processing the collected set of data using at least one technique from among natural language processing and optical character recognition.

In accordance with an exemplary embodiment, the operations may further include storing the collected set of data in a set of databases. The set of databases corresponds to at least one from among SQL databases and non-SQL databases.

In accordance with an exemplary embodiment, prior to performing the financial analysis, the operations may include performing a natural language processing-based sentiment analysis on the collected set of data and utilizing a cluster of machine learning models to identify emerging market opportunities.

In accordance with an exemplary embodiment, the set of data may include at least one from among environmental, social and governance data, industry data, financial statements and reports, industry reports, social media data, and income reports.

In accordance with an exemplary embodiment, the plurality of features may include at least one from among revenue growth, profitability metrics, liquidity analysis, and capital expenditure.

In accordance with an exemplary embodiment, the plurality of investment risks may include at least one from among debt levels and liquidity risks, regulatory risks, market volatility risks, and technological obsolescence risks.

According to yet another aspect of the present disclosure, a non-transitory computer-readable storage medium storing instructions for providing a sustainable investment analysis is disclosed. The instructions include executable code which, when executed by at least one processor, may cause the processor to collect a set of data associated with an investment industry from a plurality of sources; determine a plurality of patterns from the collected set of data using at least one machine learning-based model. The at least one machine-learning-based model is configured to identify trends and correlations within the set of data. The executable code when executed may cause the processor to evaluate sustainability for the collected set of data based on the plurality of patterns; perform a financial analysis for the collected set of data and emerging market opportunities to extract a plurality of features, based on the evaluated sustainability and the plurality of patterns; forecast growth of the investment industry using the at least one machine learning-based model to predict future growth of the investment industry, based on the financial analysis and the plurality of patterns; identify a plurality of investment risks associated with the collected set of data based on the forecasted growth of the investment industry; and generate personalized investment recommendations based on at least: the financial analysis, predicted future industry growth and the plurality of investment risks. The personalized investment recommendations are tailored to individual investor profiles and preferences.

In accordance with an exemplary embodiment, the processor may further be configured to display the personalized investment recommendations to a plurality of users through an interactive dashboard.

In accordance with an exemplary embodiment, to collect the set of data, the processor may be configured to pre-process the collected set of data using at least one technique from among natural language processing and optical character recognition.

In accordance with an exemplary embodiment, the processor may further be configured to store the collected set of data in a set of databases. The set of databases corresponds to at least one from among SQL databases and non-SQL databases.

In accordance with an exemplary embodiment, prior to performing the financial analysis, the processor may be configured to perform a natural language processing-based sentiment analysis on the collected set of data; and utilize a cluster of machine learning models to identify emerging market opportunities.

In accordance with an exemplary embodiment, the set of data may include at least one from among environmental, social and governance data, industry data, financial statements and reports, industry reports, social media data, and income reports.

In accordance with an exemplary embodiment, the plurality of features may include at least one from among revenue growth, profitability metrics, liquidity analysis, and capital expenditure.

In accordance with an exemplary embodiment, the plurality of investment risks may include at least one from among debt levels and liquidity risks, regulatory risks, market volatility risks, and technological obsolescence risks.

### BRIEF DESCRIPTION OF THE DRAWINGS

The present disclosure is further described in the detailed description which follows, about the noted plurality of drawings, by way of non-limiting examples of exemplary embodiments of the present disclosure, in which characters represent like elements throughout the several views of the drawings.

FIG. 1 illustrates an exemplary system for providing a sustainable investment analysis, in accordance with an exemplary embodiment of the present disclosure.

FIG. 2 illustrates an exemplary diagram of a network environment for providing a sustainable investment analysis, in accordance with an exemplary embodiment of the present disclosure.

FIG. 3 illustrates another exemplary system for providing a sustainable investment analysis, in accordance with an exemplary embodiment of the present disclosure.

FIG. 4 illustrates an exemplary environment for a system for providing a sustainable investment analysis, in accordance with an exemplary embodiment of the present disclosure.

FIG. 5 illustrates an exemplary flow chart depicting a method for providing a sustainable investment analysis, in accordance with an exemplary embodiment of the present disclosure.

### DETAILED DESCRIPTION

Exemplary embodiments now will be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items. Also, as used herein, the phrase “at least one” means and includes “one or more” and such phrases or terms can be used interchangeably.

Unless otherwise defined, all terms (including technical and scientific terms) used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections and the actual physical connections may be different.

In addition, all logical units and/or controllers described and depicted in the figures include the software and/or hardware components required for the unit to function. Further, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the disclosure. It will be apparent, however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer-readable medium having instructions stored thereon for one or more aspects of the present technology as described and illustrated by way of the examples herein. The instructions in some examples include executable code that, when executed by one or more processors, causes the processors to carry out steps necessary to implement the methods of the examples of this technology that are described and illustrated herein.

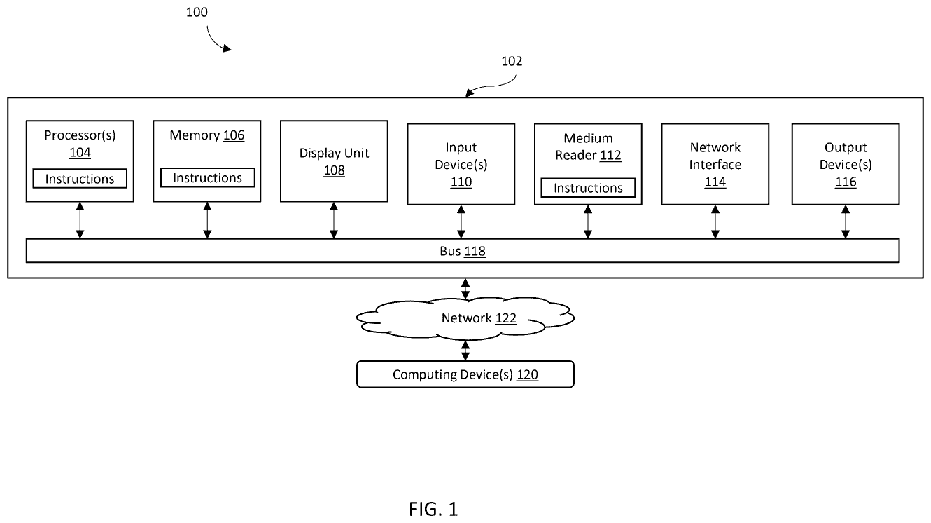

FIG. 1 illustrates an exemplary system 100 for providing a sustainable investment analysis, in accordance with an exemplary embodiment of the present disclosure. The exemplary system 100 shown may include a computer system 102 which is generally indicated. The term “computer system” may also be referred to as “computing device” and such phrases/terms can be used interchangeably in the specification.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud-based environment. Even further, the instructions may be operative in such cloud-based computing environment.

In a networked deployment, the computer system 102 may operate in the capacity of a server or as a client-user computer in a server-client user network environment, a client-user computer in a cloud-based computing environment, or as a peer computer system in peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application-specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in or coupled to, a single device or multiple devices.

The computer system 102 may also include a computer memory 106. The computer memory 106 may include a static memory, a dynamic memory, or both in communication. Memories described herein are tangible storage mediums that can store data and executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories, as described herein, may be random access memory (RAM), read-only memory (ROM), flash memory, electrically programmable read-only memory (EPROM), electrically erasable programmable read-only memory (EEPROM), registers, a hard disk, a cache, a removable disk, tape, compact disk read-only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. As regards the present disclosure, the computer memory 106 may comprise any combination of memories or a single storage.

The computer system 102 may further include a display unit 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art will appreciate that various embodiments of the computer system 102 may include multiple input devices 110. Moreover, those skilled in the art will further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor 104, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as but not limited to, a network interface 114 and an output device 116. The output device 116 may include but is not limited to, a speaker, an audio out, a video out, a remote-controlled output, a printer, or any combination thereof. Additionally, the term “Network interface” may also be referred to as “Communication interface” and such phrases/terms can be used interchangeably in the specifications.

Each of the components of the computer system 102 may be interconnected and communicate via a bus 118 or other communication link. As shown in FIG. 1, the components may each be interconnected and communicate via an internal bus. However, those skilled in the art will appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computing devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near-field communication, ultra-band, or any combination thereof. Those skilled in the art will appreciate that additional networks 122 which are known and understood may additionally or alternatively be used and that the exemplary networks 122 are not limiting or exhaustive. Also, while the network 122 is shown in FIG. 1 as a wireless network, those skilled in the art will appreciate that the network 122 may also be a wired network.

The additional computing device 120 is shown in FIG. 1 as a personal computer. However, those skilled in the art will appreciate that, in alternative embodiments of the present application, the computing device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Those skilled in the art appreciate that the above-listed devices are merely exemplary devices and that the computing device 120 may be any additional device or apparatus commonly known and understood in the art without departing from the scope of the present application. For example, the computing device 120 may be the same or similar to the computer system 102. Furthermore, those skilled in the art will similarly understand that the device may be any combination of devices and apparatuses.

Those skilled in the art will appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor 104 described herein may be used to support a virtual processing environment.

As described herein, various embodiments provide methods and systems for providing sustainable investment analysis.

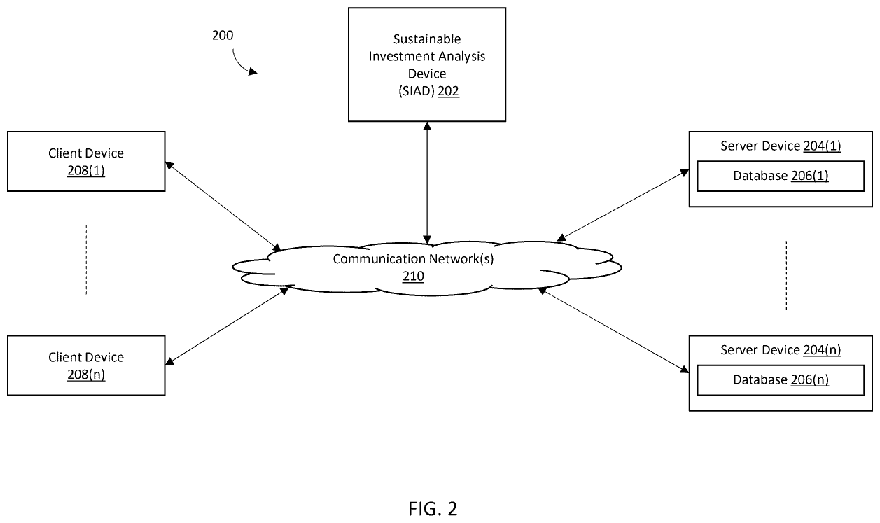

Referring to FIG. 2, a schematic diagram of an exemplary network environment 200 for providing a sustainable investment analysis is illustrated. In an exemplary embodiment, the method is executable on any networked computer platform, such as, for example, a personal computer (PC).

The method for providing a sustainable investment analysis may be executed by a sustainable investment analysis device (SIAD) 202. The SIAD 202 may be the same or similar to the computer system 102 as described with respect to FIG. 1. The SIAD 202 may store one or more applications that may include executable instructions that, when executed by the SIAD 202, cause the SIAD 202 to perform desired actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

In a non-limiting example, the application(s) may be operative in a cloud-based computing environment. The application(s) may be executed within or as a virtual machine(s) or virtual server(s) that may be managed in a cloud-based computing environment. Also, the application(s), and even the SIAD 202 itself, may be located in the virtual server(s) running in a cloud-based computing environment rather than being tied to one or more specific physical network computing devices. Also, the application(s) may be running in one or more virtual machines (VMs) executing on the SIAD 202. Additionally, in one or more embodiments of this technology, virtual machine(s) running on the SIAD 202 may be managed or supervised by a hypervisor.

In the network environment 200 of FIG. 2, the SIAD 202 is coupled to a plurality of server devices 204(1)-204(n) that hosts a plurality of databases 206(1)-206(n), and also to a plurality of client devices 208(1)-208(n) via communication network(s) 210. A communication interface of the SIAD 202, such as the network interface 114 of the computer system 102 of FIG. 1, operatively couples and communicates between the SIAD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the SIAD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides several advantages including methods, non-transitory computer-readable media, and SIADs that efficiently implement the method to automate rotation of the digital document in the cloud-native environment using the serverless function.

By way of example only, the communication network(s) 210 may include local area network(s) (LAN(s)) or wide area network(s) (WAN(s)) and can use transmission control protocol/internet protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, tele-traffic in any suitable form (e.g., voice, modem, and the like), public switched telephone networks (PSTNs), ethernet-based packet data networks (PDNs), combinations thereof, and the like.

The SIAD 202 may be a standalone device or integrated with one or more other devices or apparatuses, such as one or more of the server devices 204(1)-204(n), for example. In one particular example, the SIAD 202 may include or be hosted by one of the server devices 204(1)-204(n), and other arrangements are also possible. Moreover, one or more of the devices of the SIAD 202 may be in a same or a different communication network including one or more public, private, or cloud-based networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the SIAD 202 via the communication network(s) 210 according to the hypertext transfer protocol (HTTP)-based and/or javascript object notation (JSON) protocol, for example, although other protocols may also be used.

The server devices 204(1)-204(n) may be hardware or software or may represent a system with multiple servers in a pool, which may include internal or external networks. The server devices 204(1)-204(n) host the databases or repositories 206(1)-206(n) that are configured to store data related to a rotation schedule, digital document, stage identifier, etc.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to-peer architecture, virtual machines, or within a cloud-based architecture, for example. Thus, the technology disclosed herein is not to be construed as being limited to a single environment and other configurations and architectures are also envisaged.

The plurality of client devices 208(1)-208(n) may also be the same or similar to the computer system 102 or the computing device 120 as described with respect to FIG. 1, including any features or combination of features described with respect thereto. For example, the client devices 208(1)-208(n) in this example may include any type of computing device that can interact with the SIAD 202 via communication network(s) 210. Accordingly, the client devices 208(1)-208(n) may be mobile computing devices, desktop computing devices, laptop computing devices, tablet computing devices, or the like, that host chat, e-mail, or voice-to-text applications, for example. In an exemplary embodiment, at least one client device 208 is a wireless mobile communication device, e.g., a smartphone.

The client devices 208(1)-208(n) may run interface applications, such as standard web browsers or standalone client applications, which may provide an interface to communicate with the SIAD 202 via the communication network(s) 210 in order to communicate user requests and information. The client devices 208(1)-208(n) may further include, among other features, a display device, such as a display unit or touchscreen, and/or an input device, such as a keyboard, for example.

Although the exemplary network environment 200 with the SIAD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the SIAD 202, the server devices 204(1)-204(n), or the client devices 208(1)-208(n), for example, may be configured to operate as virtual instances on the same physical machine. In other words, one or more of the SIAD 202, the server devices 204(1)-204(n), or the client devices 208(1)-208(n) may operate on the same physical device rather than as separate devices communicating through communication network(s) 210. Additionally, there may be more or fewer SIADs 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only tele-traffic in any suitable form (e.g., voice and modem), wireless traffic networks, cellular traffic networks, packet data networks (PDNs), the Internet, intranets, and combinations thereof.

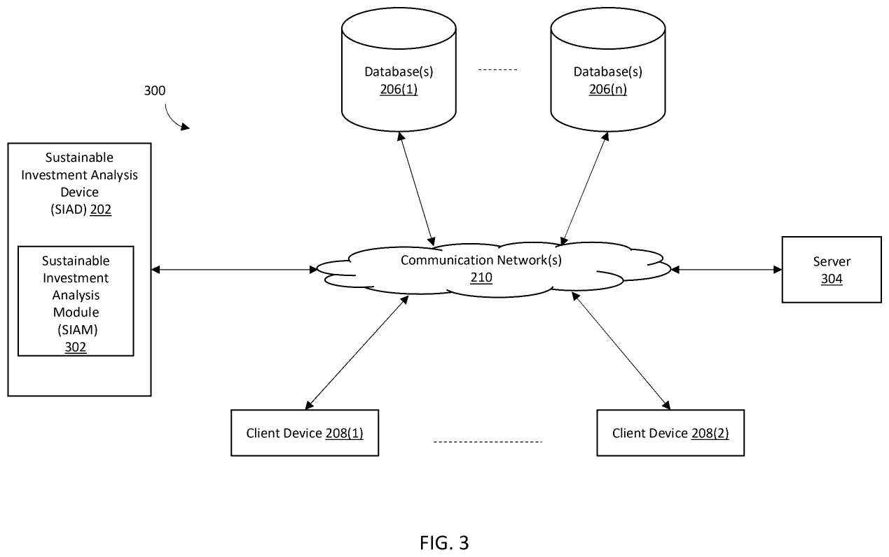

FIG. 3 illustrates an exemplary system 300 for providing a sustainable investment analysis, in accordance with an exemplary embodiment. As illustrated in FIG. 3, according to exemplary embodiments, the system 300 may comprise a sustainable investment analysis device (SIAD) 202 including a sustainable investment analysis module (SIAM) 302 that may be connected to a server 304, a database(s) 206(1) . . . 206(n), a plurality of client devices 208 (1) . . . 208(2) connected via a communication network 210, but the disclosure is not limited thereto.

The SIAD 202 as described and shown in FIG. 3 includes the SIAM 302, although it may include other rules, policies, modules, databases, or applications, for example. As will be described below, the SIAM 302 is configured to carry out a method to automate rotation of a digital document in a cloud-native environment using a serverless function.

An exemplary system 300 for enabling a mechanism to provide a sustainable investment analysis of FIG. 2 is shown as being executed in FIG. 3. Specifically, a first client device 208(1) and a second client device 208(2) are illustrated as being in communication with the SIAD 202. In this regard, the first client device 208(1) and the second client device 208(2) may be “clients” of the SIAD 202 and are described herein as such. Nevertheless, it is to be known and understood that the first client device 208(1) and/or the second client device 208(2) need not necessarily be “clients” of the SIAD 202, or any entity described in association therewith herein. Any additional or alternative relationship may exist between either or both of the first client device 208(1) and the second client device 208(2) and the SIAD 202, or no relationship may exist.

Further, the SIAD 202 is illustrated as being able to access one or more repositories 206(1) . . . 206(n). The SIAM 302 may be configured to access these repositories/databases to provide a method to automate rotation of a digital document in a cloud-native environment using a serverless function.

The first client device 208(1) may be, for example, a smartphone. The first client device 208(1) may be any additional device described herein. The second client device 208(2) may be, for example, a personal computer (PC). The second client device 208(2) may also be any additional device described herein.

The process may be executed via the communication network(s) 210, which may comprise plural networks as described above. For example, in an exemplary embodiment, either or both the first client device 208(1) and the second client device 208(2) may communicate with the 202 via broadband or cellular communication. These embodiments are merely exemplary and are not limiting or exhaustive.

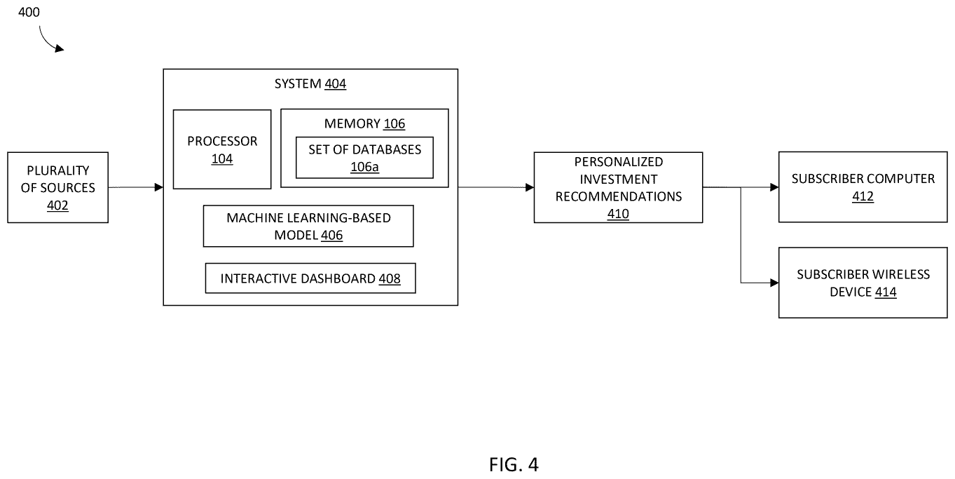

FIG. 4 illustrates an exemplary environment 400 for a system 404 for providing a sustainable investment analysis, in accordance with an exemplary embodiment of the present disclosure. The system 404 may be similar to a computer system 102 and a computing device 120 of FIG. 1.

The system 404 includes a processor 104, a memory 106 and at least one machine learning-based model 406. The processor 104 and the memory 106 may be the same as described in FIG. 1. The processor 104 is configured to collect a set of data associated with an investment industry from a plurality of sources 402. The set of data may include at least one from among environmental data, social and governance (ESG) data, industry data, financial statements and reports, industry reports, social media data, and income reports. In an exemplary embodiment, environmental, social and governance data may include carbon footprint reports, employee diversity reports, and the like. Further, the financial statements and reports may include SEC filings, balance sheets, and the like. The SEC filings are official documents that publicly traded companies must submit to the Securities and Exchange Commission (SEC), providing details about their financial performance, operations, and significant events that may impact investors' decisions. In addition, industry reports may include government regulations, news articles, market research and the like. The social media data may include public perception, controversies, and the like. Further, the income reports may include income details, bank transaction details, and the like.

In an exemplary embodiment, the set of data may be collected using web scrapping, and an Application Programming Interface (API) integration. Web scraping is a technique of extracting data from websites. The processor 104 may automatically collect the set of data from various websites based on pre-defined criteria, turning unstructured web content into structured data for further use. The API allows one system to communicate with another. The processor 104 may integrate with APIs to collect the set of data from the plurality of sources 402. The plurality of sources 402 may be external sources or systems such as social media, websites, third-party databases, cloud services, financial data providers, customer relationship management (CRM) Systems, and the like.

To collect the set of data, the processor 104 may further be configured to pre-process the set of data using at least one technique from among natural language processing (NLP) and optical character recognition (OCR). The pre-processing may refer to transforming raw data into a structured format (the set of data) and normalization. In general, NLP is a technology that allows a computer to understand, interpret, and manipulate human language. In an exemplary embodiment, the processor 104 may analyze textual data of the set of data (like text from documents, websites, or messages) to extract meaning, classify, or summarize content of the set of data. The NLP may include tokenization, named entity recognition, and word embeddings for normalization of the data. In addition, OCR is a technology used to convert different types of documents (like scanned paper documents or images containing text) into machine-readable text. The processor 104 may handle and process data from images or scanned documents (present in the set of data) to extract and work with text.

The NPL pre-processing into a structured format and normalization also presents content from the collected data in a form that will minimize the power consumption of the downstream at least one machine learning-based model 406 (discussed below). Specifically, the more compact an input to an AI/ML, the less power the AI/ML will consume in processing the input. The NPL pre-processing thus excludes information from the raw data that is of minimal relevance, per predetermined criteria, to the downstream AI/ML operations, thereby saving electrical power.

The processor 104 may further be configured to store the collected set of data in a set of databases. In an embodiment, the set of databases may be the memory 406. In another embodiment, the set of databases 106a may be part of the memory 406 (as shown in FIG. 4). In yet another embodiment, the set of databases 106a may be a separate entity associated with the processor 104 and the memory 106. The set of databases 106a may correspond to one of: SQL databases and non-SQL databases. In an exemplary embodiment, SQL databases such as relational databases may be used for storing the set of data (such as structured financial data). In another exemplary embodiment, non-SQL databases may be used for storing unstructured data such as social media data, news articles, and ESG data).

The processor 104 may further be configured to determine a plurality of patterns from the collected set of data using the at least one machine learning-based model 406. The collected set of data may be analyzed using the machine learning-based model 406 to determine the plurality of patterns.

The at least one machine learning-based model 406 is preferably a specially trained, special purpose machine learning-based model trained to operate with the parameters as discussed herein as opposed to a general purpose machine learning-based model that works on a wide variety of parameters. Such a special purpose machine learning-based model consumes less power than a general purpose machine learning-based model.

In an exemplary implementation, the plurality of patterns may be associated with recurring trends, correlations, structures, and relationships identified in the collected set of data. The plurality of patterns may provide insights into aspects of sustainability, financial performance, industry trends, and a plurality of investment risks. The plurality of patterns may include market trends (e.g., rise of sustainable energy investments), financial health indicators (e.g., steady revenue growth vs. declining liquidity), sustainability signals (e.g., companies with consistent ESG commitments), investment risk patterns (e.g., regulatory compliance failures or high volatility).

In an exemplary embodiment, the machine learning-based model 406 may be dynamically updated with real-time investment performance data, after every predefined time interval. The real-time investment performance data may be received from the plurality of sources.

The processor 104 may be configured to evaluate sustainability for the collected set of data based on the plurality of patterns. To evaluate sustainability, the processor 104 may utilize the machine learning-based model 406 equipped with transformer-based natural language processing to detect potential greenwashing. The transformer-based NLP assigns varying importance (weights) to each word in a sentence, helping the machine learning-based model understand context by looking at relationships between words. In an exemplary implementation, in the sentence “The bank approved the loan.”, the word “bank” should be interpreted as a financial institution, and not a riverbank. In an exemplary embodiment, the machine learning-based model 406 may utilize decision trees and random forest algorithms to classify companies associated with the set of data as ESG leaders or laggards.

In an exemplary implementation, the machine-learning-based model 406 may utilize convolution neural networks (CNNs) and long short-term memory (LSTMs) neural networks to perform trend analysis on sustainability impact over time. In an exemplary implementation, the trend analysis may refer to the process of examining patterns, movements, and changes in data over time to make predictions and gain insights. The trend analysis may involve analysing how the environmental, social, and governance (ESG) factors evolve over time to assess long-term trends, risks, and opportunities. LSTM is a type of recurrent neural network designed to prevent neural network output for a given input from either decaying or exploding as it cycles through feedback loops, and its use thus contributes to a more stable and consistent output.

The processor 104 may be configured to perform financial analysis for the collected set of data and emerging market opportunities to extract a plurality of features, based on the evaluated sustainability and the plurality of patterns. The plurality of features may include at least one from among revenue growth, profitability metrics, liquidity analysis, and capital expenditure. In an exemplary implementation, the revenue growth may indicate that a company's revenue may grow 12% annually based on the evaluated sustainability and the plurality of patterns. The profitability metrics may depict that return on equity (ROE) increased from 8% to 14%, indicating efficient capital use. The liquidity analysis may find a stable cash flow, meaning the company may handle financial shocks. In an exemplary implementation, a capital expenditure may reveal a 40% increase in research and development, suggesting long-term sustainability investment. In an embodiment, profitability metrics may include return on assets (ROA), earnings before interest, taxes, depreciation, and amortisation (EBITDA), and the like.

The processor 104 may further be configured to forecast growth of the investment industry using the at least one machine learning-based model 406 to predict future growth of the investment industry, based on the financial analysis and the plurality of patterns. Further, prior to performing the financial analysis, the processor 104 may further be configured to perform a natural language processing-based sentiment analysis on the collected set of data. In addition, the processor 104 may be configured to utilize a cluster of machine learning models to identify emerging market opportunities. The cluster of machine learning models includes a plurality of algorithms. The emerging market opportunities may refer to new or rapidly growing sectors, industries, or investment trends that have potential for high returns and future expansion. The emerging market opportunities may arise due to technological advancements, regulatory changes, consumer demand shifts, and global economic trends.

In an exemplary embodiment, the plurality of algorithms may include time-series forecasting algorithms (LSTM, autoregressive integrated moving average (ARIMA) algorithm), K-means clustering algorithms, regression algorithms, and the like. Also, the processor 104 may be configured to forecast the growth of the investment industry based on the natural language processing-based sentiment analysis and the identified emerging market opportunities. In an exemplary implementation, the natural language processing (NLP)-based sentiment analysis may be an AI-driven technique that interprets and categorizes human language to determine whether a given text expresses positive, negative, or neutral sentiment. The NLP-based sentiment analysis may facilitate assessing market confidence, industry trends, and the plurality of investment risks by analyzing financial reports, news articles, expert opinions, and the like.

The processor 104 may be configured to identify a plurality of investment risks associated with the collected set of data based on the forecasted growth. The plurality of investment risks may refer to potential threats that may impact profitability, sustainability, and long-term viability of an investment. The plurality of investment risks may include at least one from among: debt levels and liquidity risks, regulatory risks, market volatility risks, and technological obsolescence risks. The debt levels may refer to how much debt a company has compared to its assets and revenue. The liquidity risk may be a risk that a company may not have enough cash or easily sellable assets to meet its financial obligations. In an exemplary implementation, a company with high debt risk (high debt-to-equity ratio) may struggle to pay off loans, leading to bankruptcy and a company with low liquidity risk having high cash reserves and strong cash flow may easily cover expenses and reinvest. Further, regulatory risks are risks associated with changes in laws, policies, or government regulations. The regulatory risks may negatively impact a company's operations, profits, or investment value. In an exemplary implementation, if a company relies on government subsidies, and the subsidies are removed, it causes revenue to drop. Market volatility risks may be the risks of unexpected and extreme price fluctuations in stocks, commodities, or investment assets due to economic events, political instability, or investor sentiment. In an exemplary implementation, the stock price may fall by 50% in one day due to a bad earnings report or global crisis. In addition, technological obsolescence risks are the risks associated with a company's technology, products, or business model (such as a company's product may become outdated due to rapid innovation and new competitors). For Example: a smartphone company fails to innovate while competitors launch better, faster models, causing a drop in market share.

The processor 104 may be configured to generate personalized investment recommendations 410 based on at least one from among the financial analysis, predicted future industry growth and the plurality of investment risks. The personalized investment recommendations 410 are tailored to individual investor profiles and preferences. The processor 104 may be further configured to display the personalized investment recommendations 410 to a plurality of users through an interactive dashboard 408. The plurality of users may be investors. In an exemplary embodiment, the processor 104 may be configured to generate the personalized investment recommendations 410 based on investor's preferences, risk tolerance, and financial goals. The investor's preferences, risk tolerance, and financial goals may be gathered from the plurality of users through the interactive dashboard 408 that has a user interface for the investors to communicate with the system 404. In an exemplary implementation, a conservative investor focused on ESG compliance prefers low-risk investments, wants companies with strong ESG compliance, and looks for stable financial returns over rapid growth. The personalized investment recommendations 410 for this investor may be a “Strong Buy” for “ABC Energy Share” that is leading renewable energy company investing in wind and solar power and has stable revenue growth and low market volatility. Also, “ABC Energy Share” has high ESG rating due to carbon-neutral energy projects.

Recommendations may be sent to the subscriber computer 412 and/or the subscriber wireless device 414 as appropriate.

In an exemplary implementation, imagine Sarah, an investor looking to invest in sustainable industries like renewable energy, but unsure which companies offer the best long-term growth. She uses an AI-powered sustainable investment analysis system (the system 404), which collects real-time data from ESG reports, financial statements, government policies, and market trends. The machine learning-based model 406 of the system 404 applies Natural Language Processing (NLP) and a plurality of algorithms to extract meaningful insights, ensuring that the data is standardized and reliable. For instance, the machine learning-based model 406 identifies that Company A claims to be carbon-neutral, but sentiment analysis detects negative news about hidden pollution, helping Sarah avoid misleading ESG claims.

Next, the machine learning-based model 406 may perform financial analysis by evaluating revenue growth, profitability, liquidity risks, and capital expenditure (CAPEX). Using regression techniques and clustering algorithms, the machine learning-based model 406 may predict which companies are financially stable and have strong growth potential. The machine learning-based model 406 may find that Company B, a green hydrogen innovator, has increasing revenue and high CAPEX, signaling expansion, while Company C has excessive debt and liquidity risks, making it a poor investment. This allows Sarah to focus on companies that are both financially strong and genuinely sustainable.

To ensure long-term growth, the machine learning-based model 406 may perform industry trend analysis and risk assessment. Using time-series forecasting (LSTM, ARIMA) and topic modeling (LDA, clustering), the machine learning-based model 406 may identify that solar energy demand is set to grow by 30% in five years and that green hydrogen is an emerging investment theme with government incentives. The machine learning-based model 406 may also flag regulatory and market volatility risks, warning Sarah about Company D, which faces lawsuits over faulty solar panels. This helps her mitigate risks by choosing companies with stable market positioning and fewer regulatory challenges.

Finally, the machine learning-based model 406 may generate the personalized investment recommendations 410, ranking companies based on sustainability scores, financial health, market growth potential, and risk factors. It suggests Sarah invests in Company B (green hydrogen leader) and Company E (solar innovator) while avoiding companies with greenwashing risks, excessive debt, or regulatory challenges. By leveraging AI-driven insights, Sarah confidently builds a high-growth, low-risk, and ESG-compliant investment portfolio, ensuring both profitability and a positive environmental impact.

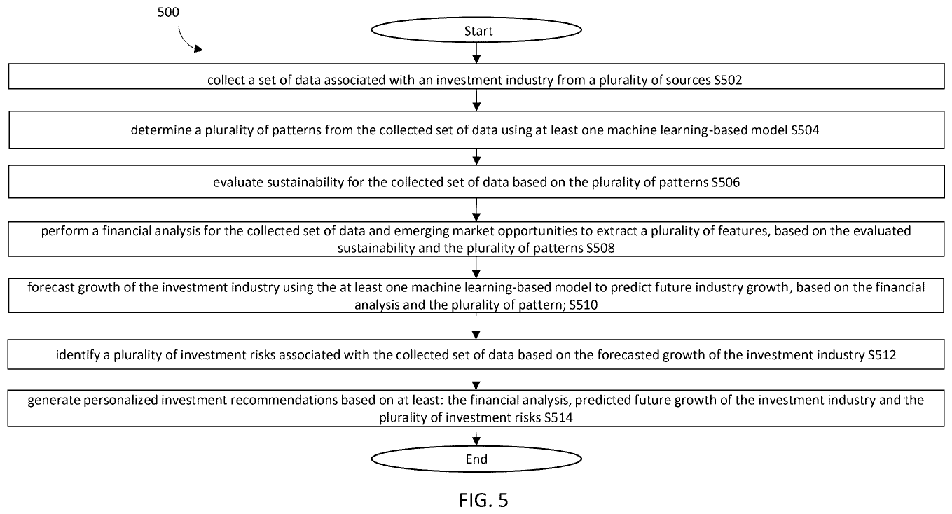

FIG. 5 illustrates an exemplary flowchart depicting a method 500 for providing sustainable investment analysis, in accordance with an exemplary embodiment of the present disclosure.

The method 500 begins following a need for providing a sustainable investment analysis to a plurality of users. The method 500 is implemented by at least one processor 104. In an implementation, the method 500 may be performed by an exemplary system (herein after system) that may be a computing device 120 of FIG. 1 and may be performed by the system 404 of FIG. 4.

At step S502, the method 500 includes collecting a set of data associated with an investment industry from a plurality of sources 402 (as shown in FIG. 4). The set of data may include at least one from among environmental data, social and governance (ESG) data, industry data, financial statements and reports, industry reports, social media data, and income reports. In an embodiment, the ESG data may include carbon footprint reports, employee diversity reports, and the like. Further, financial statements and reports may include SEC filings, balance sheets, and the like. The SEC filings are official documents that publicly traded companies must submit to the SEC, providing details about their financial performance, operations, and significant events that may impact investors' decisions. In addition, the industry reports may include government regulations, news articles, market research and the like. The social media data may include public perception, controversies, and the like. Further, income reports may include income details, bank transaction details, and the like.

To collect the set of data, the method 500 may include pre-processing the set of data using at least one technique from among natural language processing (NLP) and optical character recognition (OCR). The pre-processing may refer to transforming raw data into a structured format (the set of data) and normalization. The NLP is a technology that allows a computer to understand, interpret, and manipulate human language. In an exemplary embodiment, the processor 104 may analyze textual data of the set of data (like text from documents, websites, or messages) to extract meaning, classify, or summarize content of the set of data. The NLP may include tokenization, named entity recognition, and word embeddings for normalization of the data. In addition, OCR is a technology used to convert different types of documents (like scanned paper documents or images containing text) into machine-readable text. The processor 104 may handle and process data from images or scanned documents (present in the set of data) to extract and work with text.

The NPL pre-processing into a structured format and normalization also presents content from the collected data in a form that will minimize the power consumption of the downstream at least one machine learning-based model 406 (discussed below). Specifically, the more compact an input to an AI/ML, the less power the AI/ML will consume in processing the input. The NPL pre-processing thus excludes information from the raw data that is of minimal relevance, per predetermined criteria, to the downstream AI/ML operations.

The method 500 may include storing the collected set of data in a set of databases. In an exemplary embodiment, the set of databases may be a memory 106. In another embodiment, the set of databases may be part of the memory 106. In yet another exemplary embodiment, the set of databases may be a separate entity associated with the processor 104 and the memory 106. The set of databases may correspond to one of SQL databases and non-SQL databases.

At step S504, the method 500 includes determining a plurality of patterns from the collected set of data using at least one machine learning-based model 406. The collected set of data may be analyzed using the machine learning-based model 406 to determine the plurality of patterns. In an example, the plurality of patterns may be associated with recurring trends, correlations, structures, and relationships identified in the collected set of data. The plurality of patterns may provide insights into aspects of sustainability, financial performance, industry trends, and a plurality of investment risks. The plurality of patterns may include market trends (e.g., rise of sustainable energy investments), financial health indicators (e.g., steady revenue growth vs. declining liquidity), sustainability signals (e.g., companies with consistent ESG commitments), investment risk patterns (e.g., regulatory compliance failures or high volatility).

At step S506, the method 500 includes evaluating sustainability for the collected set of data based on the plurality of patterns. To evaluate sustainability, the processor 104 may utilize the machine learning-based model 406 equipped with transformer-based natural language processing to detect potential greenwashing. The transformer-based NLP may assign different importance (weights) to each word in a sentence, helping the machine learning-based model understand context by looking at relationships between words. In an exemplary implementation, in the sentence “The bank approved the loan.”, the word “bank” should be interpreted as a financial institution, and not a riverbank. In an embodiment, the machine learning-based model 406 may utilize decision trees and random forest algorithms to classify companies associated with the set of data as ESG leaders or laggards.

In an exemplary implementation, the machine-learning-based model 406 may utilize convolution neural networks (CNNs) and Long Short-Term Memory neural networks (LSTMs) to perform trend analysis on sustainability impact over time. The trend analysis may refer to the process of examining patterns, movements, and changes in data over time to make predictions and gain insights. In an exemplary embodiment, trend analysis may involve analysing how environmental, social, and governance (ESG) factors evolve over time to assess long-term trends, risks, and opportunities. LSTM is a type of recurrent neural network designed to prevent neural network output for a given input from either decaying or exploding as it cycles through feedback loops.

At step S508, the method 500 includes performing financial analysis for the collected set of data and emerging market opportunities to extract a plurality of features, based on the evaluated sustainability and the plurality of patterns. The plurality of features may include at least one from among revenue growth, profitability metrics, liquidity analysis, and capital expenditure. In an exemplary implementation, the revenue growth may indicate that a company's revenue may grow 12% annually based on the evaluated sustainability and the plurality of patterns. The profitability metrics may depict that return on equity (ROE) increased from 8% to 14%, indicating efficient capital use. The liquidity analysis finds a stable cash flow, meaning the company may handle financial shocks. In an exemplary implementation, a capital expenditure reveals a 40% increase in Research and Development, suggesting long-term sustainability investment. In an exemplary embodiment, profitability metrics may include return on assets (ROA), earnings before interest, taxes, depreciation, and amortisation (EBITDA), and the like.

At step S510, the method 500 includes forecasting growth of the investment industry using the at least one machine learning-based model to predict future industry growth, based on the financial analysis. Prior to performing the financial analysis, the method 500 includes performing, by the processor 104 a natural language processing-based sentiment analysis on the collected set of data. In addition, the processor 104 may be configured to utilize a cluster of machine learning models to identify emerging market opportunities. Emerging market opportunities may refer to new or rapidly growing sectors, industries, or investment trends that have potential for high returns and future expansion. The emerging market opportunities may arise due to technological advancements, regulatory changes, consumer demand shifts, and global economic trends.

At step S512, the method 500 includes identifying a plurality of investment risks associated with the collected set of data based on the forecasted growth of the investment industry. The plurality of investment risks may refer to potential threats that may impact profitability, sustainability, and long-term viability of an investment. The plurality of investment risks may include at least one from among: debt levels and liquidity risks, regulatory risks, market volatility risks, and technological obsolescence risks. The debt levels may refer to how much debt a company has compared to its assets and revenue. The liquidity risk may be a risk that a company may not have enough cash or easily sellable assets to meet its financial obligations. In an exemplary implementation, a company with high debt risk (high debt-to-equity ratio) may struggle to pay off loans, leading to bankruptcy and a company with low liquidity risk having high cash reserves and strong cash flow may easily cover expenses and reinvest.

Further, regulatory risks may be the risks associated with changes in laws, policies, or government regulations. The regulatory risks may negatively impact a company's operations, profits, or investment value. In an exemplary implementation, if a company relies on government subsidies, then its revenue may drop when the subsidies are removed.

The market volatility risks may be the risks of unexpected and extreme price fluctuations in stocks, commodities, or investment assets due to economic events, political instability, or investor sentiment. In an exemplary implementation, a stock price may fall by 50% in one day due to a bad earnings report or global crisis.

The technological obsolescence risks may be the risks associated with a company's technology, products, or business model (such as a company's product may become outdated due to rapid innovation and new competitors). For example, a smartphone company may fail to innovate while competitors launch better, faster models, causing a drop in market share.

At step S514, the method 500 includes generating personalized investment recommendations based on at least: the financial analysis, predicted future industry growth and the plurality of investment risks. In an exemplary embodiment, the processor 104 may be further configured to generate the personalized investment recommendations 410 based on investor's preferences, risk tolerance, and financial goals. The investor's preferences, risk tolerance, and financial goals may be gathered from the plurality of users through the interactive dashboard 408 that has a user interface for the investors to communicate with the system 404.

In an exemplary implementation, a conservative investor focused on ESG compliance prefers low-risk investments, wants companies with strong ESG compliance, and looks for stable financial returns over rapid growth. The personalized investment recommendations 410 for this investor may be a “Strong Buy” for “ABC Energy Share” that is leading renewable energy company investing in wind and solar power and has stable revenue growth and low market volatility. Also, “ABC Energy Share” has high ESG rating due to carbon-neutral energy projects.

The method 500 terminates after step S514.

Sending recommendations are challenging when attempting to notify a remote subscriber whose computer is offline (not connected to the Internet) at the time of the recommendation, since many recommendations are time sensitive. If sent to a remote subscriber's phone rather than computer, receiving the information by phone notification on the phone would require the remote subscriber to sort through large amounts of data on a relatively small screen, which is ineffective. This presents an Internet-centric challenge of alerting a subscriber with time sensitive information when the subscriber's computer is offline.

The recommendations herein can be delivered in a manner than can address these problems. Specifically, a recommendation viewer application can be provided to an end use for installation on the remote subscriber computer for later receipt of a recommendation alert.

The recommendations when generated can be converted into a recommendation alert formatted to include high level information more easily readable in a phone environment, along with a universal resource locator (URL) to a web page at a data source which contains further information on the recommendations. Subsequently, the recommendation alert is transmitted to the remote subscriber's wireless device in accordance with a transmission schedule. After receiving the alert, the remote subscriber can connect their wireless device to the remote subscriber's computer. The alert causes the subscriber's computer to auto-launch the recommendation application previously provided to display the alert. When connected to the Internet, the subscriber at the subscriber computer may then click on the URL in the alert to use the recommendation viewer application to access the more detailed information about the recommendations from the data source.

The methodology thus addresses the Internet-centric challenge of alerting a subscriber with time sensitive information when the subscriber's computer is offline. This is addressed by transmitting the alert over a wireless communication channel to activate the recommendation application, which causes the alert to display and enables the connection of the remote subscriber computer to the data source over the Internet when the remote subscriber computer comes online.

According to an aspect of the disclosure, a methodology for providing the noted recommendations is provided. The methodology includes: providing a recommendation viewer application to a subscriber for installation on a remote subscriber computer; generating recommendations as otherwise set forth herein; generating a recommendation alert formatted as a summary of the recommendations and a universal resource locator (URL) that specifies the location of the data source storing the recommendation; transmitting the recommendation alert over a wireless communication channel to a wireless device associated with the subscriber based upon the destination address of the URL; and wherein the recommendation alert activates the recommendation viewer application to cause the recommendation alert to display on the remote subscriber computer and to enable connection via the URL to the data source over the Internet when the wireless device is locally connected to the remote subscriber computer and the remote subscriber computer comes online.

It will be appreciated by the person skilled in the art that the disclosed method offers an intelligent solution for providing risk assessment and evaluation for a set of entities.

The present disclosure provides several advantages as given below. The present disclosure provides a system and method for providing a sustainable investment analysis. The present disclosure provides a data-driven, AI-powered investment analysis system that enhances decision-making accuracy, reduces risks, and promotes sustainable investing. By leveraging machine learning, NLP, and deep learning models, it ensures real-time, unbiased insights into ESG compliance, financial stability, market trends, and emerging investment opportunities. It helps investors avoid greenwashing, predict industry growth, and mitigate financial risks such as regulatory changes and market volatility. The system actively supports investments that contribute to long-term environmental health, social equity, and responsible governance. It encourages capital flow toward companies with measurable sustainability impact, reinforcing global efforts toward a greener economy. Additionally, the system personalizes investment recommendations based on individual preferences, enabling users to maximize returns while aligning with sustainability goals, making it an essential tool for modern, responsible investing.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The terms “computer-readable medium” and “computer-readable storage medium” shall also include any medium that is capable of storing, encoding, or carrying a set of instructions for execution by a processor 104 or that causes a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tape, or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

According to an aspect of the present disclosure, a non-transitory computer-readable storage medium storing instructions for providing sustainable investment analysis is disclosed. The instructions include executable code which, when executed by a processor, may cause the processor to collect a set of data associated with an investment industry from a plurality of sources; determine a plurality of patterns from the collected set of data using at least one machine learning-based model; evaluate sustainability for the collected set of data based on the plurality of patterns; perform financial analysis for the collected set of data to extract a plurality of features, based on the evaluated sustainability and the plurality of patterns; forecast growth of the investment industry using the at least one machine learning-based model to predict future industry growth, based on the financial analysis; identify a plurality of investment risks associated with the collected set of data based on the forecasted growth; and generate personalized investment recommendations based on at least: the financial analysis, predicted future industry growth and the plurality of investment risks.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

What is claimed is:

1. A method for providing a sustainable investment analysis, the method being implemented by at least one processor, the method comprising:
collecting, by the at least one processor, a set of data associated with an investment industry from a plurality of sources;
determining, by the at least one processor, a plurality of patterns from the collected set of data using at least one machine learning-based model, wherein the at least one machine learning-based model is configured to identify trends and correlations within the set of data;
evaluating, by the at least one processor, sustainability for the collected set of data based on the plurality of patterns;
performing, by the at least one processor, a financial analysis on the collected set of data and emerging market opportunities to extract a plurality of features, based on the evaluated sustainability and the plurality of patterns;
forecasting, by the at least one processor, growth of the investment industry using the at least one machine learning-based model, to predict future growth of the investment industry, based on the financial analysis and the plurality of patterns;
identifying, by the at least one processor, a plurality of investment risks associated with the collected set of data based on the forecasted growth of the investment industry; and
generating, by the at least one processor, personalized investment recommendations based on at least one from among the financial analysis, predicted future growth of the investment industry and the plurality of investment risks, wherein the personalized investment recommendations are tailored to individual investor profiles and preferences.

2. The method as claimed in claim 1, the method further comprising:
displaying, by the at least one processor, the personalized investment recommendations to a plurality of users through an interactive dashboard.

3. The method as claimed in claim 1, wherein collecting the set of data comprises:
pre-processing, by the at least one processor, the collected set of data using at least one technique from among natural language processing and optical character recognition.

4. The method as claimed in claim 1, the method further comprising:
storing, by the at least one processor, the collected set of data in a set of databases, wherein the set of databases corresponds to at least one from among SQL databases and non-SQL databases.

5. The method as claimed in claim 1, wherein prior to performing the financial analysis, the method comprises:
performing, by the at least one processor, a natural language processing-based sentiment analysis on the collected set of data; and
utilizing, by the at least one processor, a cluster of machine learning models to identify the emerging market opportunities.

6. The method as claimed in claim 1, wherein the set of data comprises at least one from among environmental data, social and governance data, an industry data, financial statements and reports, industry reports, social media data and income reports.

7. The method as claimed in claim 1, wherein the plurality of features comprises at least one from among revenue growth, profitability metrics, liquidity analysis, and capital expenditure.

8. The method as claimed in claim 1, wherein the plurality of investment risks comprises at least one from among debt levels and liquidity risks, regulatory risks, market volatility risks, and technological obsolescence risks.

9. A computing device configured to provide a sustainable investment analysis, the computing device comprising:
a processor;
a memory storing instructions; and
a communication interface coupled to each of the processor and the memory, wherein the processor is programmed to cooperate with the instructions to perform operations comprising:
collect a set of data associated with an investment industry from a plurality of sources;
determine a plurality of patterns from the collected set of data using at least one machine learning-based model, wherein the at least one machine learning-based model is configured to identify trends and correlations within the set of data;
evaluate sustainability for the collected set of data based on the plurality of patterns;
perform a financial analysis on the collected set of data and emerging market opportunities to extract a plurality of features, based on the evaluated sustainability and the plurality of patterns;
forecast growth of the investment industry using the at least one machine learning-based model to predict future growth of the investment industry, based on the financial analysis and the plurality of patterns;
identify a plurality of investment risks associated with the collected set of data based on the forecasted growth of the investment industry; and
generate personalized investment recommendations based on at least one from among the financial analysis, predicted future growth of the investment industry and the plurality of investment risks, wherein the personalized investment recommendations are tailored to individual investor profiles and preferences.

10. The computing device as claimed in claim 9, wherein the operations further comprise displaying the personalized investment recommendations to a plurality of users through an interactive dashboard.

11. The computing device as claimed in claim 9, wherein to collect the set of data, the operations further comprise pre-processing the collected set of data using at least one technique from among natural language processing and optical character recognition.

12. The computing device as claimed in claim 9, wherein the operations further comprise storing the collected set of data in a set of databases, wherein the set of databases corresponds to at least one from among SQL databases and non-SQL databases.

13. The computing device as claimed in claim 9, wherein prior to performing the financial analysis, the operations comprise:
performing a natural language processing-based sentiment analysis on the collected set of data; and
utilizing a cluster of machine learning models to identify the emerging market opportunities.

14. The computing device as claimed in claim 9, wherein the set of data comprises at least one from among environmental data, social and governance data, an industry data, financial statements and reports, industry reports, social media data, and income reports.

15. The computing device as claimed in claim 9, wherein the plurality of features comprises at least one from among revenue growth, profitability metrics, liquidity analysis, and capital expenditure.

16. The computing device as claimed in claim 9, wherein the plurality of investment risks comprises at least one from among: debt levels and liquidity risks, regulatory risks, market volatility risks, and technological obsolescence risks.

17. A non-transitory computer readable storage medium storing instruction for providing a sustainable investment analysis, the instructions comprising executable code which when executed by at least one processor, causes the processor to perform operations comprising:
collecting, by the at least one processor, a set of data associated with an investment industry from a plurality of sources;
determining, by the at least one processor, a plurality of patterns from the collected set of data using at least one machine learning-based model, wherein the at least one machine learning-based model is configured to identify trends and correlations within the set of data;
evaluating, by the at least one processor, sustainability for the collected set of data based on the plurality of patterns;
performing, by the at least one processor, a financial analysis on the collected set of data and emerging market opportunities to extract a plurality of features, based on the evaluated sustainability and the plurality of patterns;
forecasting, by the at least one processor, growth of the investment industry using the at least one machine learning-based model, to predict future growth of the investment industry, based on the financial analysis and the plurality of patterns;
identifying, by the at least one processor, a plurality of investment risks associated with the collected set of data based on the forecasted growth of the investment industry; and
generating, by the at least one processor, personalized investment recommendations based on at least one from among the financial analysis, predicted future growth of the investment industry and the plurality of investment risks, wherein the personalized investment recommendations are tailored to individual investor profiles and preferences.

18. The non-transitory computer readable storage medium as claimed in claim 17, wherein the operations further comprise:
displaying, by the at least one processor, the personalized investment recommendations to a plurality of users through an interactive dashboard.

19. The non-transitory computer readable storage medium as claimed in claim 17, wherein collecting the set of data comprises:
pre-processing, the collected set of data using at least one technique from among natural language processing and optical character recognition.

20. The non-transitory computer readable medium as claimed in claim 17, wherein prior to performing the financial analysis, the operations comprise:
performing, a natural language processing-based sentiment analysis on the collected set of data; and
utilizing, a cluster of machine learning models to identify the emerging market opportunities.
